(19) United States
(12) Patent Application Publication
(10) Pub. No.: US 2026/0106798 A1
(43) Pub. Date: Apr. 16, 2026

(54) AUTONOMOUS CLOUD-BASED POLICY VALIDATION

(71) Applicant: OPTUM, INC., Minnetonka, MN (US)

(72) Inventors: Amit Sharma, Bangalore (IN); Mahesh Gidwani, Bengaluru (IN); Gukan V, Bengaluru (IN); Shiva, Bengaluru (IN); Sudhir Kamlesh Sharma, Bengaluru (IN); Varsha V, Bengaluru (IN)

(21) Appl. No.: 18/911,948

(22) Filed: Oct. 10, 2024

(51) Int. Cl. H04L 41/0894

(52) U.S. Cl. CPC H04L 41/0894

(57) ABSTRACT

Techniques for autonomously validating cloud-based policies can obtain information about a policy deployed in a cloud computing environment, automatically determine which scenario(s)/resource configuration(s) to test, and cause the cloud computing environment to automatically instantiate, modify, or disable one or more cloud resources according to the scenario(s)/resource configuration(s). After the cloud computing environment applies the policy to the new, modified, and/or disabled resource(s), the techniques can generate/store data indicating the compliance status of the resource(s) according to the policy. The techniques can improve the functioning of the cloud computing environment and/or related frontend systems, and provide cloud policy validation in an efficient, accurate, and scalable manner.

### TECHNICAL FIELD

The present disclosure generally relates to policy validation techniques, and more particularly, to techniques for autonomously and efficiently validating policies in a cloud environment.

### BACKGROUND

Cloud-based policies are policies deployed in cloud computing environments, and generally serve to enforce computing-and/or network-related compliance standards of an organization (e.g., compliance standards of the organization that is subject to the policies, and/or compliance standards of third parties such as government entities). Generally, cloud-based policies may be used to enforce compliance for any purpose, such as cybersecurity, regulatory compliance, resource consistency, reducing costs, and so on. Cloud-based policies are typically implemented by broader cloud-based services/platforms, such as Azure® from Microsoft®, or Google Cloud® from Google®, etc., which may apply the policies to instances in which resources associated with those services/platforms are accessed, used, modified, etc. For example, a cloud computing platform that enables users to set up and maintain storage accounts may apply one or more policies that govern the creation and/or use of the storage accounts. As another example, a cloud computing platform that enables users to set up and use virtual machines may apply one or more policies that govern the set up and/or use of the virtual machines. A given cloud computing platform may support the creation, modification, maintenance, etc., of any number of resource types (e.g., storage accounts, virtual machines, network addresses, etc.), and each of these resource types may be associated with any number of attributes. For example, a storage account resource may be associated with an attribute indicative of a maximum size of the storage account, an attribute indicative of whether public/unrestricted access to the storage account is permitted, etc. As another example, a network address resource may be associated with only an attribute indicating a range of permissible Internet Protocol (IP) addresses, geographic regions in which the range of IP addresses can be assigned, etc.

Cloud-based policies (or “cloud policies,” or simply “policies”) that do not operate correctly or as expected can have numerous deleterious effects on the backend of the cloud computing system in which the cloud policy is deployed (e.g., one or more servers or other nodes, pods, containers, cloud orchestrators, cloud schedulers, virtual machines) as well as the frontend of the cloud computing system (e.g., end-user computing device) that is using resources associated with the cloud policy. For example, such cloud policies may introduce security vulnerabilities to the cloud computing system, such as by allowing malicious actors or code to infiltrate the cloud environment using coordinated attacks, unsecured ports, configuration vulnerabilities, etc., wreaking havoc on the expected operation of the cloud computing system. These and other security vulnerabilities may degrade, stop, or even destroy access to, availability of, and/or physical or data integrity of the services and/or resources of the cloud computing system. Such vulnerabilities may additionally or alternatively leak (e.g., by incorrectly provisioning permissions, containers, domains, or the like such that a non-malicious party receives or is otherwise able to access data they would otherwise be unable to access but for the misconfiguration) or allow unauthorized access to private and/or encrypted data stored by the cloud computing system. Moreover, even a single cloud policy that operates incorrectly or not as expected may cause computing faults or anomalies on the front end and/or backend of the cloud computing system, wasting computing resources (e.g., processing cycles, network resources, storage resources, power resources) and/or causing system failures (e.g., blue screens or other fatal errors, failure to establish a network connection, incorrectly provisioning or storing data).

Further, measures to correct such cloud policies and resolve any problems (e.g., security infractions) as a result thereof can require code and system log analysis, identifying frontend and/or backend effects of the security breach or leak, recoding of the policy for compliance, disabling or reconfiguring improperly configured resources and recreating new compliant resources, etc., which can also involve the expenditure of additional computing resources. Such deleterious effects are multiplied when considering each policy can include numerous resources, multiple policies may be deployed by an organization at any number of cloud service providers, and multiple organizations may host or otherwise access a cloud computing system.

Thus, it can be critical that cloud policies operate correctly and as expected. Accordingly, some organizations perform validation processes on their applicable cloud policies (e.g., cloud policies applicable to computing activities associated with the businesses, operations, customers, etc., of the organizations). However, current approaches for validating cloud policies in a manual or semi-automated manner are insufficient, especially for large organizations to which numerous cloud policies and/or cloud policy rules apply. Moreover, validation can be complicated by the fact that cloud-based policies are not locally implemented/coded, but are instead created and implemented by a third party (typically, the provider of the cloud computing platform).

### BRIEF DESCRIPTION OF THE DRAWINGS

The figures described below depict embodiments for purposes of illustration only. One skilled in the art will readily recognize from the following discussion that alternative embodiments of the systems and methods illustrated herein may be employed without departing from the principles of the disclosure described herein. The detailed description is described with reference to the accompanying figures. In the figures, the same reference number appearing in different figures indicates a same or similar item.

FIG. 1 depicts an example computing environment in which various embodiments of the present disclosure can be implemented.

FIG. 2A depicts an example policy validation process, in accordance with various embodiments described herein.

FIG. 2B depicts an additional or alternate example policy validation process, in accordance with various embodiments described herein.

FIG. 3A depicts an example user interface for validating a storage access policy, in accordance with various embodiments described herein.

FIG. 3B depicts an example user interface providing a first notification, in accordance with various embodiments described herein.

FIG. 3C depicts an example compliance report, in accordance with various embodiments described herein.

FIG. 4 depicts a flow diagram of an example computer-implemented method, in accordance with various embodiments described herein.

### DETAILED DESCRIPTION

As explained above in the Background section, cloud policies that operate in an incorrect or unexpected manner can create numerous problems (e.g., security vulnerabilities, computing system faults or failures, inefficient computing resource usage, etc.) that, even if detected, can be difficult or costly to resolve. Broadly speaking, the present disclosure relates to techniques (e.g., hardware, software, machine-learned model(s), or a combination thereof; process(es)) for autonomously validating cloud-based policies in an efficient, accurate, and scalable manner.

Generally, the disclosed techniques can obtain information about a policy deployed in a cloud computing environment, cause the cloud computing environment to automatically instantiate, modify, or disable one or more cloud resources that are appropriate for testing/validating the policy, and generate/store data indicating the compliance status of those resource(s) according to the policy.

To obtain the policy information, for example, the techniques may fetch a policy definition from the cloud computing environment, with the policy definition specifying one or more resource types associated with the policy, attributes that correspond to those resource type(s), policy rules that impose conditions based on values of those attributes, and possibly metadata such as policy name, version, etc. Resource types may include, for example, a storage account, a virtual machine, a virtual network, a network address (e.g., IP address), and so on. Attributes may include, for example, whether public access is permitted for the corresponding resource, a maximum storage size for the corresponding resource, a network address range for the corresponding resource, and so on.

To cause the cloud computing environment to automatically instantiate, modify, or disable cloud resource(s) appropriate for testing/validating the policy, the disclosed techniques can use the obtained policy information (e.g., policy definition), and use the policy information to determine which resource type(s) are relevant to the policy as well as the specific resource configuration(s) to test against the policy for the resource type(s). For example, the disclosed techniques may determine that the policy applies to storage accounts, and that different scenarios/resource configurations should be tested in which (1) a storage account is set up so as to allow public access, and (2) another storage account is set up so as to deny public access. As another example, the disclosed techniques may determine that the policy applies to virtual machines, and that different configurations/scenarios should be tested in which (1) a virtual machine is set up so as to allow access/use from a first geographic region, and (2) another virtual machine is set up so as to deny access/use from the first geographic region. In some embodiments, the disclosed techniques determine the scenarios/resource configurations based in part on user-entered information. For example, a user may enter, for a particular resource type associated with a particular policy, attribute values that are expected to be compliant (or expected to be non-compliant) with the policy. In such cases, the disclosed techniques may determine which scenarios/resource configurations to test using the user-entered attribute values in addition to the policy information.

To cause the cloud computing environment to create/modify/disable resource(s) to be tested against the policy, the disclosed techniques can generate new resource data (e.g., instructions executable by processor(s) of the cloud computing environment) in accordance with the resource configurations (e.g., particular attribute values), and provide the new resource data to the cloud computing environment.

These disclosed techniques may improve the functioning of a cloud computing system, by avoiding adverse effects such as those noted above for cloud policies that are faulty (e.g., operate incorrectly or in an unexpected manner). For example, the disclosed techniques enable the near-term identification of faulty policies before a misconfigured resource is taken advantage of by a malicious actor, before cloud system security is compromised by leakage, before a misconfigured resource leads to computing failures or degradation, and so on. Moreover, the disclosed techniques may provide real-time or near real-time insight into resource misconfiguration, and/or real-time or near real-time reconfiguration of misconfigured resources, to bring such resources into compliance with a cloud policy. The autonomous policy validation techniques disclosed herein can also achieve significant efficiency improvements over conventional (e.g., manual) techniques with respect to the time and/or computing resources required to sufficiently test a cloud policy. Further still, the disclosed techniques are highly scalable in that the techniques can not only determine compliance status in an automated manner, but also can decide which resource configuration(s) to test in an automated manner.

The disclosed techniques include specific features other than what is well-understood, routine, conventional activity in the field, and add unconventional steps that demonstrate, in various embodiments, particular useful applications, e.g., obtaining, by querying a cloud computing environment, policy information of a policy deployed in the cloud computing environment; determining, based at least in part on the policy information, resource information of one or more resource types; determining, based at least in part on the resource information, one or more resource configurations to be tested against the policy for a first resource type of the one or more resource types; generating, based at least in part on a first resource configuration of the one or more resource configurations, new resource data including processor-executable instructions to newly instantiate a new resource or modify or disable an existing resource; providing the new resource data to the cloud computing environment to cause the cloud computing environment to instantiate the new resource or modify or disable the existing resource; and generating, by the one or more processors, one or more data objects indicating a compliance status, according to policy, of the new resource or the modified or disabled existing resource.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art. Moreover, the techniques described herein may be readily applied in any suitable field for any suitable purpose.

### Example Computing Environment

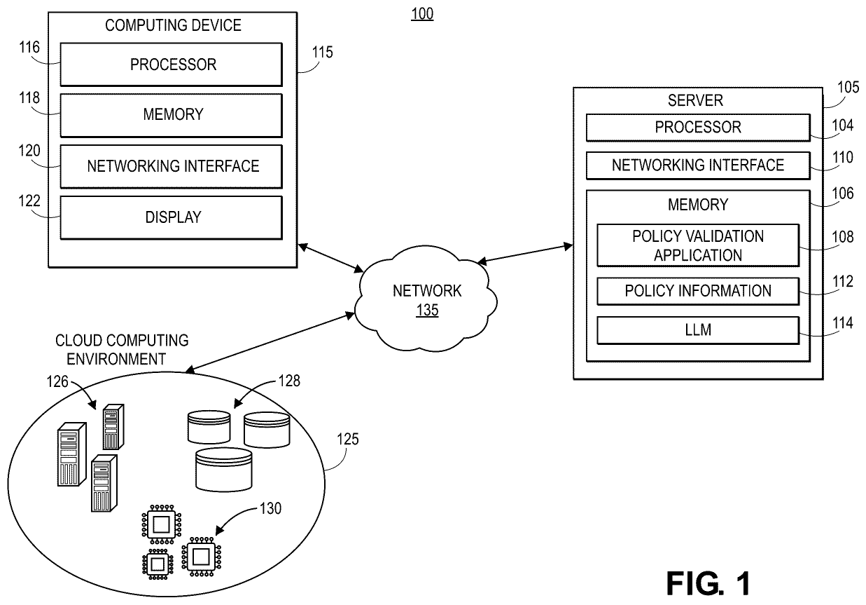

FIG. 1 depicts an example computing environment 100 in which various embodiments of the present disclosure may be implemented. In some embodiments, the example computing environment 100 autonomously validates policies. Generally, the example computing environment 100 includes a server 105, a computing device 115, and a cloud computing environment 125. It should be appreciated that, while the server 105, computing device 115, and cloud computing environment 125 are illustrated in FIG. 1 as single components, the example computing environment 100 may include multiple (e.g., dozens, hundreds, thousands) of servers 105, computing devices 115, and/or cloud computing environments 125.

The server 105 may be associated with an organization that creates, selects, and/or is subject to one or more cloud policies. In some examples, creating a policy may comprise accessing the cloud computing environment 125 (e.g., using an application programming interface (API)), and using a tool of a cloud computing platform supported by the cloud computing environment 125 to select, create, and/or define one or more policies. Creating or defining a policy may include, for example, selecting, entering, and/or defining particular resource type(s) (e.g., a storage account, or a virtual machine, etc.), particular attributes of the resource type(s) that are used/considered by the policy, and/or particular rules (e.g., conditional logic) that specify outcomes/effects (e.g., a notification of non-compliance, or restricting creation of a particular instance of a resource, etc.) based on values of those attributes. In some embodiments, creating or defining a policy also includes entering or selecting certain metadata, such as a policy name, a policy version, a policy description, and so on. In some embodiments, the cloud computing environment 125 generates and stores one or more data objects (e.g., data structures) that are indicative of the policy resource types, resource attributes, policy rules, and/or metadata. Such data object(s) may constitute or provide a “definition” of the policy.

In the example of FIG. 1, the server 105 performs at least some of the functionalities and techniques disclosed herein, such as validating policies of the organization. The server 105 may include only one server, or multiple servers that are co-located and/or remotely distributed. The server 105 may be part of a cloud network or may otherwise communicate with other hardware or software components within one or more cloud computing environments to send, retrieve, or otherwise analyze data or information described herein. In some example embodiments, the computing environment 100 comprises an on-premise computing environment, a multi-cloud computing environment, a public cloud computing environment, a private cloud computing environment, and/or a hybrid cloud computing environment. The server 105 includes a processor 104, a memory 106, and/or a networking interface 110.

The processor 104 may include any suitable number of processors and/or processor types. In some examples, the processor 104 includes one or more central processing units (CPUs), one or more graphics processing units (GPUs), one or more tensor processing units (TPUs), one or more field-programmable gate arrays (FPGAs), one or more application-specific integrated circuits (ASICs), and/or the like. Generally, the processor 104 comprises hardware configured to execute instructions (e.g., processor-executable code/instructions) stored in the memory 106.

The networking interface 110 may comprise one or more hardware components to generally enable the server 105 to communicate via one or more network(s) (e.g., network 135) with other components and/or devices of the computing environment 100, such as the computing device 115, the cloud computing environment 125, the server 105 itself (e.g., between components of a server, between two or more servers of two or more servers composing the server 105), and/or other suitable devices or combinations thereof. More specifically, the networking interface 110 enables the server 105 to communicate with any component of the example computing environment 100 across the network 135. The networking interface 110 may comprise hardware and/or software that operates according to at least one communication protocol of the network 135.

The network 135 may include wired and/or wireless communication network(s) such as a cellular network (e.g., 5G®, 4G LTE®, 3G®), a Wi-Fi® network (802.11 standards), a microwave access network (e.g., WiMAX®), and/or any other suitable wide area network (WAN), local area network (LAN), personal area network (PAN), etc. Moreover, the network 135 may be a single communication network, or may include multiple communication networks of one or more types (e.g., one or more wired and/or PANs or LANs, and/or one or more WANs such as the Internet). In some embodiments, the network 135 includes multiple, entirely distinct networks (e.g., one or more networks for communications between server 105 and computing device 115, and a separate, Bluetooth® or wireless LAN (WLAN) network for communications between server 105 and computing device 115, and so on).

The memory 106 may include any suitable memory type(s), including one or more volatile memories (e.g., dynamic and/or static random-access memory (RAM)) and/or non-volatile memories (e.g., read-only memory (ROM), erasable programmable ROM (EPROM), electrically EROM (EEROM), NAND flash, and/or solid state drive(s) (SSD(s))), all or any of which are examples of non-transitory computer-readable media. In some examples, the memory 106 stores one or more of: an operating system; one or more software components (e.g., firmware, application(s), binary, source code, executable instructions, machine-learned model(s)); transient data and/or code loaded and/or operated on by one or more software component(s); and/or other suitable components/data. In some examples, the memory 106 stores a policy validation application 108, policy information 112, and/or a machine-learned model 114. The memory 106 may additionally or alternatively be and/or store one or more databases.

The policy validation application 108, when executed by the processor 104, performs one or more policy validation functions, such as retrieving the policy information 112 from the cloud computing environment 125 for local storage in memory 106, determining resource information based upon the policy information 112, determining and/or generating data indicating one or more resource configurations to validate a policy, determining compliance of resource configurations (e.g., by causing the cloud computing environment 125 to instantiate resources according to such configurations, and obtaining the policy compliance status from the cloud computing environment 125, or the like), and other suitable functions as discussed further herein. In some embodiments a user initiates operation of the policy validation application 108, while in other embodiments the validation application 108 is automatically initiated by server 105 (e.g., in response to a trigger at one or more scheduled times, or continuously, etc.). In some embodiments, the policy validation application 108 is configured to obtain the policy information 112 from the cloud computing environment 125 deploying the policy (via the network 135) by querying an API exposed by the cloud computing environment 125.

The policy information 112 may include data and/or information (e.g., stored as a policy data structure) associated with one or more policies of an organization and/or other applicable entity (hereinafter “organization”). A policy may indicate and/or enforce (e.g., via executable code or by acting as a reference for executable code) the rules, procedures, guidelines, and/or standards of the organization respective to a service offered by the cloud computing environment 125 to the organization. The policy may include security policies (e.g., data encryption policies, access control policies, identity and access management policies), compliance policies (e.g., data privacy policies, audit and logging policies, retention policies), resource management policies (e.g., cost management policies, resource provisioning policies, usage monitoring policies), operational policies (e.g., incident response policies, disaster recovery policies, change management policies), data management policies (e.g., data classification policies, data sovereignty policies, data lifecycle management policies), network policies (e.g., network security policies, virtual private network policies, traffic management policies), application management policies (e.g., deployment policies, patch management policies, development and operations policies), user management policies (e.g., onboarding and offboarding policies, user activity monitoring policies, acceptable use policies), and/or any other suitable policy related to computational resource provisioning, monitoring, operations, and/or the like. In some embodiments, the policy information 112 includes and/or indicates, for one or more policies, respective policy definitions (e.g., resource type(s) associated with the policies, resource attributes associated with the policies, conditional logic or other rules associated with the policies, and/or associated metadata such as policy name, version, description, etc.). The policies may be enforced upon deployment to the cloud computing environment 125, and upon application of the policy by the cloud computing environment 125 to new resources (and/or to existing resources on a periodic and/or other basis).

The memory 106 stores a machine-learned (ML) model 114, which may comprise generative machine-learned model component(s), such as a transformer-based machine-learned model (e.g., a large-language model model (LLM), an embedding model, a diffusion model, and/or the like); and may additionally or alternatively comprise other machine-learned model component(s), such as neural network(s), decision tree(s), and/or the like. In some examples, the machine-learned model 114 may be trained to use text as input and may generate text (e.g., process-executable code/instructions to create a resource) or, in other embodiments, may be a multimodal LLM that operates upon and/or generates text and also other types of content (e.g., text, images, audio, etc.). The machine-learned model 114 may receive a text prompt (referred to herein at times as simply a “prompt”) as an input, process the text prompt, and output text content responsive to the text prompt. The machine-learned model 114 may additionally or alternatively include a deep neural network and may perform various natural language processing tasks as needed to understand a text query/prompt and generate a response to the text query/prompt, e.g., as part of a pre-processing operation and/or a post-processing operation. For example, in a pre-processing operation a neural network and/or another transformer-based machine-learned model may be trained to augment the original prompt to add sufficient context, which may be based on processing inputs determined from policy information, resource information, and/or the like determined to be associated with the prompt. In a post-processing operation, the neural network and/or another transformer-based machine-learned model may be trained to review and alter, as necessary, an output of a transformer-based machine-learned model to be suitable for use by the cloud computing environment 125 to cause changes to a resource configuration. For example, this review and alteration may comprise altering code generated by a first transformer-based machine-learned model to correct errors, translate the code to a different language used by a particular resource or cloud computing environment component, and/or the like.

The machine-learned model 114 may have a transformer-based model architecture that comprises an encoder that tokenizes the input and determines embeddings for the tokens, and a decoder that generates the output based at least in part on the embeddings. The transformer model may incorporate self-attention and/or cross-attention mechanisms to facilitate more accurate output. In some embodiments, such a transformer-based machine-learned model may include different configurations of self-and/or cross-attention, followed by neural network(s) (e.g., feedforward layer(s)), recurrent layer(s), aggregation layer(s) (e.g., using softmax, matrix multiplication, and/or other aggregation techniques), and/or the like. The machine-learned model 114 may be a general-purpose model (e.g., trained on a wide array of publicly available datasets such as web pages, documents, etc., available via the Internet) such as generative pre-trained transformer (GPT) 3.5, bi-directional encoder representations from transformers (BERT), or a domain-specific model (e.g., trained and/or fine-tuned on custom and/or proprietary datasets), such a general purpose LLM trained using datasets of code to create resources at various cloud computing environments (e.g., where the training data may comprise policy information, resource information, and/or code for causing a resource to be provisioned, instantiated, configured, reconfigured, disabled, or the like).

In some examples, the computing device 115 and/or the server 105 may include a computer (e.g., desktop computer, laptop computer, terminal), a mobile device, a wearable, augmented reality glasses/headsets, virtual reality glasses/headsets, mixed or extended reality glasses/headsets, and/or other suitable computing device. The computing device 115 includes a processor 116 (e.g., similar to the processor 104) and a memory 118 (e.g., similar to the memory 106) for storing and executing one or more software components, computer-executable instructions, etc. The computing device 115 may further include a networking interface 120 (e.g., which may be the same as or similar to the networking interface 110) and an input and/or output component 122 (e.g., a display, such as a monitor; a user input device, such as a keyboard, mouse, trackpad, gesture and/or biometric tracking device, or the like). The computing device 115 may access services, devices, and/or components of the computing environment 100 via the network 135. In some embodiments, the computing device 115 transmits and/or receives information/data associated with policy validation from the server 105 and/or the cloud computing environment 125. In some embodiments, for example, the computing device 115 may receive user input indicating a selection of resources, attributes, and/or attribute values of a policy for validation, receive notifications associated with policy validations, receive data objects representing a policy validation report from the server 105 and/or the policy validation application 108 indicating the faulty or correct (or expected or unexpected, etc.) operation of policies based upon the automated policy validation, etc.

The cloud computing environment 125 may include a variety of computing (hardware and/or software) resources made available to user computing devices and/or server 105 via the network 135, which can reduce or eliminate the need for traditional on-premises computing infrastructure. The cloud computing environment 125 may provide on-demand access to scalable computing resources via servers 126 (e.g., which may or may not include the server 105) providing services and applications, databases 128 (e.g., one or more co-located or remotely distributed databases such as relational databases, NoSQL-based databases, etc.) or other storage locations and/or devices, and/or other computing resources 130 (e.g., processors, GPUs, machine learning models, etc.). The cloud computing environment 125 may in some respects control access to, and/or usage of, the computing resources provided by the cloud computing environment 125 by applying the policies. For example, if a first resource type associated with a particular policy is a storage account, application of the policy may, in some embodiments, dictate or otherwise affect whether a particular instance of a storage account is permitted to use or access any of databases 128, and/or whether the instance of the storage account is permitted to use or access particular database management software of servers 126 and/or other computing resources 130, etc.

In at least some embodiments, the computing environment 100 validates security policies. In such embodiments, the server 105 (e.g., via the policy validation application 108) obtains the policy information 112 of one or more policies deployed in the cloud computing environment 125. The server 105 may obtain the policy information 112 (e.g., for local storage in memory 106) by querying the cloud computing environment 125 deploying the policies (e.g., via an API), for example. The server 105 determines one or more resource types of the policy, and resource information of the one or more resource types, based upon the policy information 112. The resource types may include, for example, virtual or virtually defined/delineated computing resource(s) (e.g., virtual machine(s), node(s), pod(s), cluster(s)), storage accounts, network resources (e.g., a virtual private cloud network), application resources (e.g., a managed database service such as Amazon RDS®, orchestrator(s), virtualization management component(s), container(s), scheduler(s), binar(ies) to be executed), etc.). The resource information may include at least one resource attribute and corresponding attribute value. Example resource attributes may include public accessibility (e.g., with available values of “yes” and “no”), a range of network address (e.g., a range of IP addresses), a maximum storage amount, a geographic region for which access or use is permitted or restricted, and/or any other suitable attribute of a cloud resource.

For each of one, some, or all of the resource type(s), the server 105 generates new resource data indicative of a plurality of resource configurations to validate a policy. In some embodiments, the new resource data includes at least one resource configuration that is compliant with the policy, and at least one other resource configuration that is non-compliant with the policy according to the policy information 112. In other embodiments, the new resource data includes only compliant resource configurations, or only non-compliant resource configurations. The new resource data includes processor-executable instructions that computing resources (e.g., servers 126 or other computing resources 130) execute to newly instantiate a new resource or modify or disable an existing resource in the cloud computing environment 125.

The server 105 provides/transmits the new resource data via the network 135 to the cloud computing environment 125 deploying the policy that is to be validated. Upon reception, or possibly at a later time, the new resource data causes the cloud computing environment 125 to create one or more new resources in the cloud computing environment 125 based on respective ones of the resource configuration(s), to modify one or more existing resources of the cloud computing environment 125 based on respective ones of the resource configuration(s), and/or to disable one or more existing resources of the cloud computing environment 125 based on respective ones of the resource configuration(s). The server 105 determines (e.g., via the policy validation application 108) compliance or non-compliance, with respect to the policy, of the new, modified, and/or disabled resource(s).

In some embodiments, the server 105 obtains (e.g., from the cloud computing environment 125) an indication that at least one new resource was not created at the cloud computing environment 125, or that at least one existing resource of the cloud computing environment 125 was not modified or altered, after the server 105 provided the new resource data intended to create, modify, or disable the resource. The server 105 may in response generate a notification indicating the resource(s) that was/were not created, modified, and/or disabled at the cloud computing environment 125, and transmit the notification to a computing device (e.g., computing device 115 for presentation via input and/or output component 122).

The server 105 generates one or more data objects (e.g., representing a compliance report) indicating the compliance status of the new, modified, and/or disable resource(s). The server 105 may generate the data object(s) based on a compliance status that the server 105 receives from the cloud computing environment 125 in response to the cloud computing environment 125 applying the policy to the resource(s). The server 105 may transmit the compliance report to a computing device (e.g., computing device 115, for presentation via input and/or output component 122, or to a different computing device associated with the organization).

It will be understood that the above disclosure is one example and does not necessarily describe every possible embodiment. As such, it will be further understood that alternate embodiments may include fewer, alternate, and/or additional steps or elements.

### Example Policy Validation Workflow

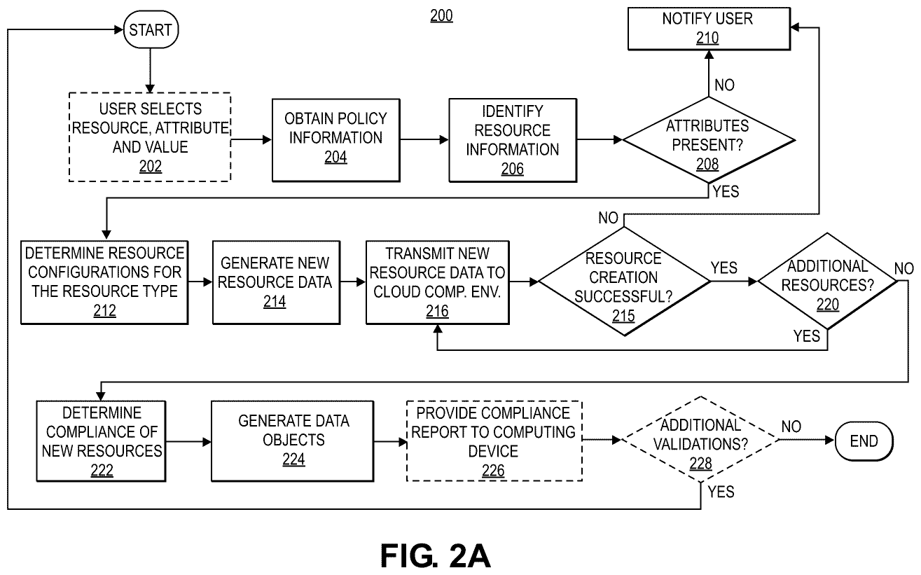

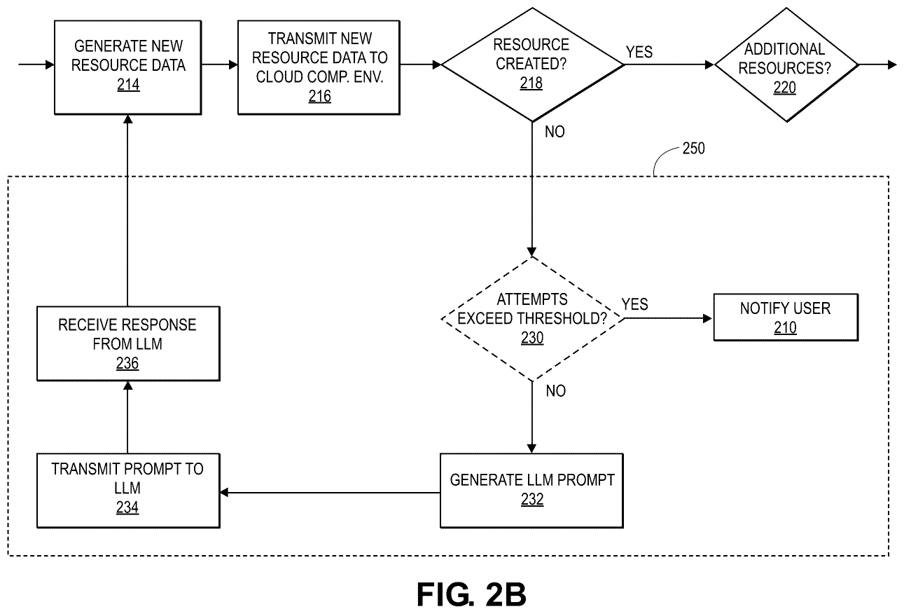

FIG. 2A depicts an example policy validation process 200, in accordance with various embodiments described herein. The example process 200 broadly illustrates steps which may be performed by components and devices (e.g., the server 105, the policy validation application 108, the computing device 115, and/or the cloud computing environment 125) of the computing environment 100. It should be understood that additional/alternative processes may also, or instead, be utilized to validate a policy.

The process 200 may begin with a user of a policy validation application (e.g., the policy validation application 108) inputting (e.g., selecting or entering) a resource type, resource attribute, and/or resource attribute value (block 202) of a policy to validate and/or an entire policy (which may itself be associated with one or more resource types, resource attributes, and/or resource attribute values). The user input may be indicative of one or more scenarios against which to validate the policy. For example, the user input may indicate attribute values of a resource attribute (for a particular resource type) that are expected to be compliant (or expected to be non-compliant) with the policy being validated. In some embodiments, a server (e.g., the server 105) hosts the policy validation application, and the user accesses the policy validation application at the server (e.g., via a user interface device at the server). In other embodiments, the user accesses the policy validation application via a computing device communicatively coupled to the server (e.g., the computing device 115 via network 135), for example a policy validation client application executing on the computing device, and/or in any other suitable manner.

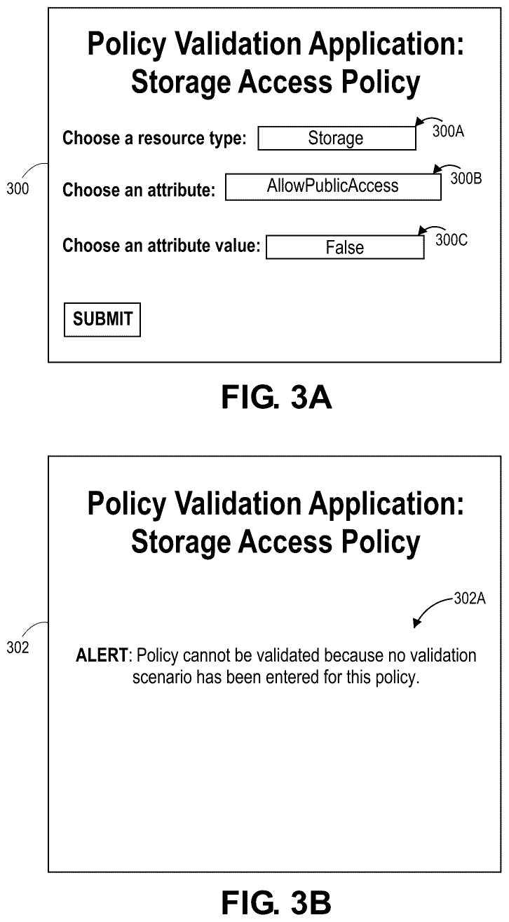

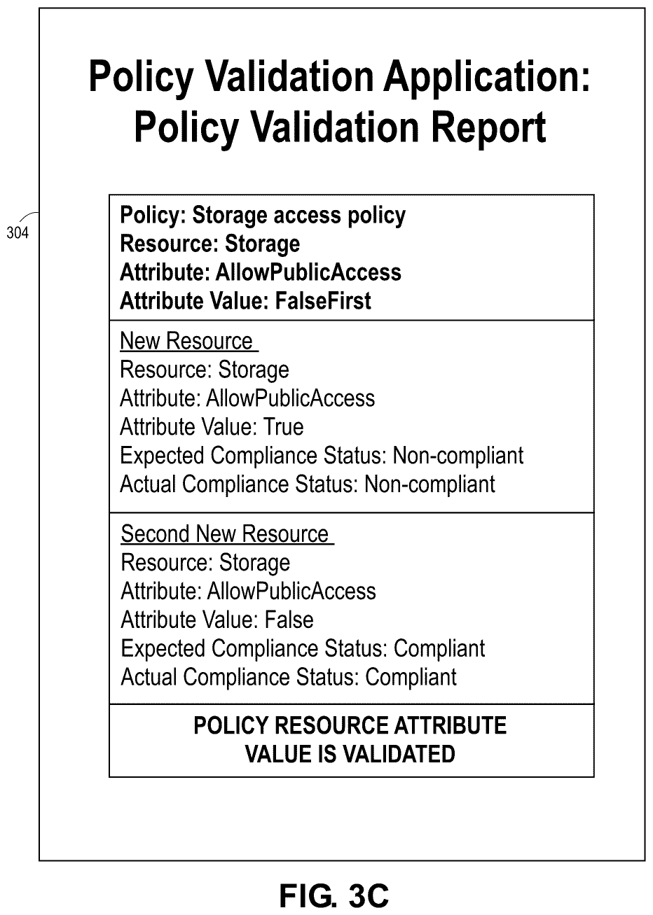

FIG. 3A depicts an example user interface 300 for setting up a validation scenario for a storage access policy, according to some embodiments. The policy validation application may generate the user interface 300, for example during the process 200 at block 202, to allow the user to select a resource type 300A, a resource attribute 300B, and a resource attribute value 300C to validate the storage access policy. The resource type 300A is a storage account resource, however in other examples, the resource type may include a computing resource, a network resource, an application resource, or any other suitable resource type of the policy being validated by the process 200. As illustrated, the example user interface 300, the user chooses “storage account” as the resource type 300A having an attribute 300B “AllowPublicAccess” associated with allowing public access to the storage resource, with the attribute value 300C being set to “False.” Accordingly, the storage access policy of the user interface 300 is expected to be valid if the storage resource does not allow public access, as indicated by the user selections.

Returning to FIG. 2A, the policy validation application obtains policy information (block 204) for the policy being validated, e.g., the policy associated with denying public access to the storage resource in the example of FIG. 3A. The policy validation application may use an API offered/exposed by a cloud computing environment (e.g., cloud computing environment 125) to fetch the policy definition, for example. In some embodiments, the policy information (e.g., the policy information 112) includes and/or otherwise indicates at least one resource attribute, and at least one corresponding attribute value, such as an AllowPublicAccess attribute having a False attribute value. The policy validation application obtains the policy information (e.g., for local storage in the memory 106) from a database (e.g., database 128 via the network 135), a cloud computing environment (e.g., the cloud computing environment 125), and/or from any other suitable source.

In at least some embodiments, the process 200 begins at block 204, the dotted lines of block 202 (and similarly other steps) indicating that the block is optional. For example, the process 200 can validate one or more and up to all policies of an organization, such that selecting a resource, resource attribute and/or resource attribute value of a particular policy is not required, as any or all resources, resource attributes, and/or resource attribute values are validated. In some such embodiments, the policy validation application obtains policy information (block 204) for any or all the policies being validated without requiring user input at optional block 202.

The process 200 may next determine resource information (block 206) of one or more resource types based upon the policy information. The resource information may include at least one resource attribute for each of one, some, or all of the resource type(s). For example, the policy validation application may parse the policy information to identify the various policies contained therein, as well as the resource type(s) indicated by a policy, and the attribute(s) of each of one, some, or all of the resource(s) indicated by the policy for a respective resource type.

In some embodiments, the process 200 includes the policy validation application determining whether a validation scenario is present for the policy (e.g., whether a user entered expected attribute values at block 202). If no validation scenario is present, the policy validation application may generate a notification indicating that no validation scenario is present (block 210). In the embodiment where the user is using the policy validation application at the server, the server may provide the notification at an output device, such as displaying the notification as a graphical user interface on a display coupled to the server. In some embodiments where the user executes the policy validation application via a computing device (e.g., the computing device 115) communicatively coupled to the server, the server may transmit the notification to the computing device, e.g., for presentation on a display of the computing device.

FIG. 3B depicts an example user interface 302 providing a first notification 302A, according to some embodiments. The policy validation application generates the user interface 302 indicating the policy cannot be validated due to a lack of validation scenarios from a user.

If at block 208 the policy validation application determines that at least one validation scenario is present, the policy validation application determines one or more resource configurations for the corresponding resource type(s) (block 212) based upon the resource information associated with a policy as well as the validation scenario(s) reflected by the user input from block 202. In some embodiments, block 206 occurs after block 210, before (or simultaneous with, etc.) block 212.

Returning to the storage access policy example, the policy information associated with the storage access policy may include a policy definition. The policy definition may include a rule that, when the value of a resource attribute representing public access is set to be True for a given resource, that resource is not compliant with the policy. In this example, the policy validation application may determine at block 212 that configuring a first resource configuration to create a first storage account that provides public account access would be non-compliant with the storage access policy, and configuring a second resource configuration to create a second storage account that does not provide public account access would be compliant with the storage access policy.

Next, the process 200 may include the policy validation application generating new resource data indicative of the resource configuration(s) determined at block 212 (block 214). The new resource data (e.g., cloud computing environment-specific commands to create cloud resources, such as processor-executable instructions) may cause the cloud computing environment to create a new resource, reconfigure a resource, and/or disable or otherwise shut down a resource. In some embodiments, the new resource data causes the cloud computing environment to modify or disable an existing resource based upon a resource configuration, rather than generate a new resource, to validate a policy. The policy validation application provides at least a portion of the new resource data to the cloud computing environment (block 216) to create the new resource (or modify or disable an existing resource) and determine the compliance status of the resource.

In some examples, generating the new resource data may comprise providing, as input to the machine-learned model 114 (e.g., an LLM), a prompt that may include information such as the current resource configuration, the policy information, an indication of the resource type and/or the resource(s) that responsible for provisioning of the resource type (e.g., an orchestration component when the resource is a container) and attendant information related to the resource for provisioning the resource type (e.g., an API address, programming language, communication protocol, or the like associated with the provisioning resource), and an instruction to generate processor-executable instructions in a language and/or via a communication protocol associated with the provisioning resource(s). In some examples, multiple provisioning resources may be identified and the prompt may further include a hierarchy or order in which to generate and/or execute the code output by the machine-learned model 114. For example, if a resource being modified is an application that is currently running in a hardware environment not permitted by a policy, the application may need to be migrated to a new hardware and software environment. In such a situation, the resources responsible for such a transition may be determined by the machine-learned model 114 in a pre-processing operation or the prompt may include resource information retrieved from a database indicating the provisioning resource(s) for instantiating and/or migrating an application. Ultimately, the machine-learned model 114 may output processor-executable instructions comprising calls to a current orchestrator and scheduler to cause the current application instance state to be captured before being shut down, and calls to a different orchestrator and scheduler associated with a different set of hardware to provision a new container or virtual machine in the different set of hardware with permissions to run the application and instantiate the container or virtual machine with the captured state of the application and start operation of the application.

In some embodiments, the policy validation application is configured to generate resource configurations for a plurality of cloud computing environments, with the different cloud computing environments potentially having different configuration requirements (e.g., syntax, commands, etc.). The policy validation application may need to interact with different cloud computing environments, e.g., if a first cloud computing environment supports applications and deploys corresponding application policies for an organization, and a second cloud computing environment supports storage resources and deploys corresponding storage polices for the organization, etc. Accordingly, in this embodiment and scenario, the policy validation application generates new resource data (block 214) for generating and/or modifying resources at both the first and second cloud computing environments when validating application policies and storage policies.

The example process 200 also includes determining whether the new resource is generated at the cloud computing environment (block 218) based on a resource configuration of the new resource data. Again, generating the new resource may include generating an entirely new resource, or modifying or disabling an existing resource. If the new resource is not generated, or if the existing resource is not modified or disabled, it may be an indication of an anomaly with the associated new resource data (e.g., an incorrectly configured new resource or other new resource configuration issue) and/or the cloud computing environment (e.g., the cloud computing environment did not receive and/or process the new resource data), either of which may prevent validation of the policy. If the policy validation application determines the new resource is not created at the cloud computing environment (e.g., such as by querying an API of the cloud computing system to determine an updated resource configuration for the new resource), the process 200 may return to block 210 providing a notification to the user associated with the non-creation of the new resource. For example, the policy validation application can generate a notification similar to the notification 302A, but instead indicating one or more new resources are not created by the cloud computing environment, and as a result, in some embodiments, the policy validation application does not validate the policy.

In some embodiments, the policy validation application uses (e.g., includes or otherwise accesses) a machine-learned model (e.g., the machine-learned model 114) when resource creation is not successful at block 218, in addition to or instead of originally using the machine-learned model 114 to generate the instructions for newly instantiating, modifying, or disabling the resource, as discussed above. FIG. 2B depicts an alternate process 250 for generating new resource data using the machine-learned model, according to some embodiments. The alternate process 250 is performed, for example, after the policy validation application determines whether the new resource is generated at the cloud computing environment (block 218). The alternate process 250 may otherwise be no different from process 200 when block 218 determines the successful creation of the new resource at the cloud computing environment. However, when the policy validation application determines at block 218 that the new resource is not created at the cloud computing environment, the alternate process 250 may include determining whether a threshold number of attempts (e.g., three attempts) to create the new resource is exceeded (block 230). The threshold number of attempts may be a value set by a user of the policy validation application, or a value set in any other suitable manner. If block 230 determines the threshold number of attempts to create the new resource is exceeded (without success), the alternate process 250 includes the policy validation application notifying the user (block 210) that the new resource is not created. Multiple failed attempts at creating the resource may be indicative, for example, of the process 250 being stuck in a loop, and the notification to the user of the multiple failed attempts can allow a user to intervene to correct the issue. If the policy validation application determines at block 230 the number of attempts to create the new resource is not exceeded, the alternate process 250 includes the policy validation application generating a prompt for the machine-learned model (block 232) associated with generating the new resource. In at least some embodiments, block 230 is an optional step as indicated by the dotted lines in FIG. 2B. In embodiments where the alternate process 250 does not include block 230, if the policy validation application determines at block 218 the new resource is not created, the alternate process 250 moves to block 232 where the policy validation application generates the machine-learned model prompt associated with generating the new resource.

At block 232, the policy validation application generates a prompt for the machine-learned model associated with generating the resource. The prompt may be, and/or include, a request for the machine-learned model to generate code for the cloud computing environment to create the new resource. For example, the prompt may indicate the specific cloud computing environment (e.g., so the code/syntax the machine-learned model generates is compatible with the cloud computing environment), the resource type, the attribute and/or attribute value, and/or other suitable information. The prompt creation may be an autonomous process by the policy validation application, or may include user input (e.g., via a user interface of the policy validation application).

The policy validation application transmits or otherwise provides the prompt to the machine-learned model (e.g., LLM) (block 234). In embodiments where the server or other computing device executing the policy validation application is interacting with a local LLM (e.g., an LLM stored locally in memory such as memory 106 or 118), providing the prompt to the LLM at block 234 includes providing the prompt to the local LLM as an input. In embodiments where the server or other computing device executing the policy validation application is interacting with a non-local LLM (e.g., a third-party LLM stored at a remote server), the policy validation application may use an API and/or other suitable communication method to provide the prompt to the LLM.

The policy validation application receives a response from the machine-learned model (block 236). The response may be received in a manner similar to that in which the prompt was provided to the machine-learned model (e.g., via an output of a local model, via an API, etc.). The response may include, for example, code the machine-learned model generates to create the new resource at the cloud computing environment, such as creating an entirely new resource, modifying an existing resource, etc.

After block 236, the alternate process 250 may end with the policy validation application generating new resource data (block 214) based on the response from the machine-learned model according to the process 200. Generating new resource data (block 214) may include, for example, sanitizing the machine-learned model response to isolate the code for generating the new resource by removing additional text from the machine-learned model response. As previously described respective to process 200, the policy validation application may transmit the new resource data to the cloud computing environment at block 216 to create, modify, or disable a resource. At block 218, the policy validation application may determine whether the new resource is created and, if the new resource is not created, in at least some embodiments the policy validation application performs the alternate process 250 starting again at block 230.

Returning again to FIG. 2A, if the policy validation application determines at block 218 the new resource creation at the cloud computing environment is successful, the policy validation application determines whether additional resources require creation at the cloud computing environment (block 220) to validate the policy. If at least one additional resource requires creation, the process 200 returns to block 216 to transmit at least a portion of the resource data (e.g., the resource data associated with creation of the additional resource) to the respective cloud computing environment.

If no additional resources require creation, the process 200 may include the policy validation application determining compliance or non-compliance of each of one, some, or all of the new, modified, or disabled resource(s) (block 222) with respect to the policy deployed in the respective cloud computing environment. Returning yet again to the storage access policy example, the cloud computing environment may create a new first storage account associated with the first resource configuration, and a new second storage account associated with the second resource configuration. The cloud computing environment applies the storage access policy to the new first and second storage accounts, allowing the policy validation application to determine the compliance of the new first and second storage accounts (block 218). For example, the policy validation application may attempt to query the cloud computing environment to determine whether the cloud computing environment (when applying the policy rule(s)) determined either or both of the two storage accounts to be compliant (e.g., as indicated by the cloud computing environment refusing to create a storage account, or providing a non-compliance warning, etc.).. If the policy validation application determines the new first storage account that provides public access is non-compliant upon application of the storage access policy, and the new second storage account that does not provide public access is compliant upon application of the storage access policy, the policy validation application may determine the storage policy is validated (e.g., because the results align with the user validation scenario(s) entered at block 202).

At block 224, the policy validation application generates one or more data objects (e.g., indicative of one or more reports, notifications, compliance data, etc.) indicating the compliance status of the plurality of new, modified, or disabled resources. The data objects may be or include any suitable data structure(s) (e.g., in tabular format with information such as compliance status descriptor, policy identifier or descriptor, resource identifier or descriptor, etc.), and/or may include unstructured data (e.g., text such as “compliant” or “non-compliant”). In some embodiments, the compliance status can have values other than a binary indicator. For example, the status may be “compliant”, “non-compliant”, “exempt”, “conflicts with another resource”, and so on. In some embodiments, generating the data objects (block 224) concludes the process 200.

In some embodiments of the process 200, the policy validation application provides (at block 226) a compliance report (e.g., compiled as, or using data from, the one or more data objects) indicating to a computing device the compliance status of the resources with the policy. The computing device may be the server executing the policy validation application (e.g., server 105), the computing device accessing the policy validation application via the server and/or associated with the entity providing the policy being validated (e.g., computing device 115), or any other suitable computing device.

FIG. 3C depicts an example compliance report 304, according to some embodiments. The example compliance report 304 indicates the policy, resource, resource attribute, and resource attribute being validated. The compliance report 304 further indicates information associated with the new first and second resources, their expected compliance status, and their actual compliance status. In the example scenario of FIG. 3C, the compliance report 304 indicates the policy is operating as expected (i.e., is validated).

In some embodiments of the process 200, at block 228 the policy validation application determines whether the process 200 is to perform additional validations (e.g., of different policies, or of different resources, attributes, and/or attribute values of the same policy, etc.). If the policy validation application performs additional validations, the process 200 starts over again at the beginning. Otherwise, the process 200 ends.

### Example Computer-Implemented Method

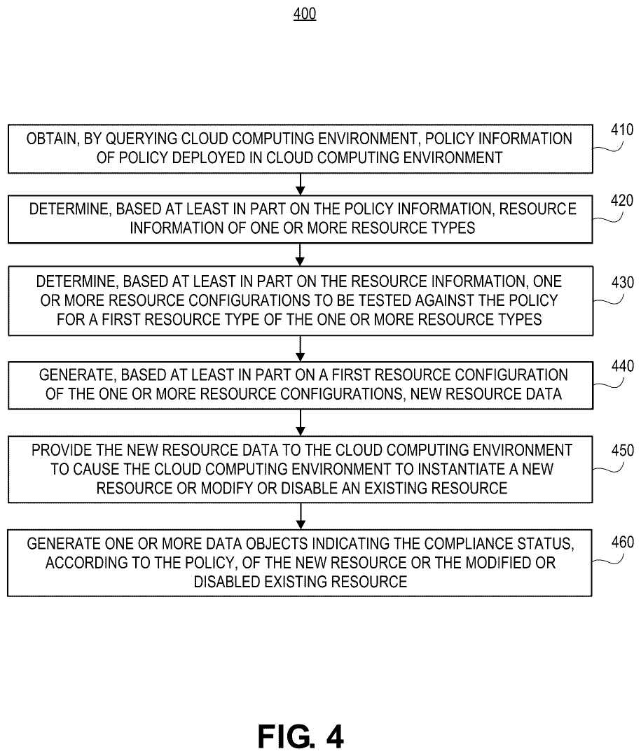

FIG. 4 depicts a flow diagram representing an example computer-implemented method 400, in accordance with various embodiments described herein. The method 400 may be implemented by one or more processors and/or devices of the example computing environment 100, such as the processors 104 and/or 116, the server 105 (e.g., via policy validation application 108), the computing device 115, and/or the cloud computing environment 125, in parallel, in series, and/or in the same or different order as presented. In some embodiments, the entire method 400 is performed by the server 105 (e.g., by the policy validation application 108).

The method 400 includes obtaining, by querying a cloud computing environment (e.g., cloud computing environment 125) policy information of a policy deployed in the cloud computing environment (block 410). For example, the policy may be associated with one or more of: security, compliance, resource management, data management, application management, or user management.

The method 400 also includes determining, based at least in part on the policy information, resource information of one or more resource types (block 420). A resource type may be, for example, a storage account resource, a virtual machine resource, or a network address resource. The resource information may be or include, for example, one or more resource configurations, and may include at least one resource attribute, and at least one corresponding attribute value, for each resource type of one, some, or all of the one or more resource types. A resource attribute may be public accessibility (e.g., with available values of “yes” and “no”), a range of network address (e.g., a range of IP addresses), a maximum storage amount, a geographic region for which access or use is permitted or restricted, or any other suitable attribute of a cloud resource.

The method 400 also includes determining, based at least in part on the resource information, one or more resource configurations to be tested against the policy for a first resource type of the one or more resource types (block 430).

The method 400 also includes generating, based at least in part on a first resource configuration of the one or more resource configurations, new resource data (block 440). In some embodiments, block 440 includes generating the new resource data using a machine-learned model (e.g., machine-learned model 114) to generate the processor-executable instructions to newly instantiate a new resource. In some of these embodiments, block 440 includes: generating initial new resource data including initial processor-executable instructions to newly instantiate the new resource; providing the initial new resource data to the cloud computing environment to cause the cloud computing environment to instantiate the new resource, and obtaining an indication that the new resource was not instantiated at the cloud computing environment. In such embodiments, block 440 may include using the machine-learned model to generate the processor-executable instructions in response to the indication that the new resource was not instantiated.

The method 400 also includes providing the new resource data to the cloud computing environment to cause the cloud computing environment to instantiate a new resource or modify or disable an existing resource (block 450).

The method 400 also includes generating one or more data objects indicating the compliance status, according to the policy, of the new resource or the modified or disabled resource (block 460).

The method 400 may repeat blocks 410 through 450 (or through 460) for one or more additional policies. Within one iteration of the method 400, the method 400 may repeat block 430 through 450 (or through 460) for one or more additional resource types of the one or more resource types. For any given resource type, the method 400 may repeat blocks 440 through 450 (or through 460) for one or more additional resource configurations of the one or more resource configurations.

In some embodiments, the one or more data objects include data of a compliance report, and the method 400 includes providing the compliance report to a computing device (e.g. computing device 115 for presentation via input and/or output component 122).

In some embodiments, the method 400 includes receiving user input indicative of one or more scenarios against which to validate the policy. In such embodiments, block 430 may include determining the one or more resource configurations further based on the user input.

In some embodiments, the policy is a first policy, the policy information is first policy information, the cloud computing environment is a first cloud computing environment, and the plurality of new resources are a first plurality of new resources. In such embodiments, the method 400 includes obtaining, by one or more processors, second policy information of a second policy deployed at a second cloud computing environment to determine compliance of a second plurality of new resources respective to the second policy. In such embodiments, the first policy is a different policy than the second policy, or the first cloud computing environment is a different cloud computing environment than the second cloud computing environment.

It is to be understood that the actions of the method 400 may be performed any suitable number of times (e.g., to validate multiple policies, resources, attributes, and/or attribute values). Moreover, the actions of the method 400 may be performed in any suitable order, and/or may include fewer, additional, or different actions.

### EXAMPLES

Example 1. A computer-implemented method comprising: obtaining, by one or more processors and by querying a cloud computing environment, policy information of a policy deployed in the cloud computing environment; determining, by the one or more processors and based at least in part on the policy information, resource information of one or more resource types; determining, by the one or more processors and based at least in part on the resource information, one or more resource configurations to be tested against the policy for a first resource type of the one or more resource types; generating, by the one or more processors and based at least in part on a first resource configuration of the one or more resource configurations, new resource data including processor-executable instructions to newly instantiate a new resource or modify or disable an existing resource; providing, by the one or more processors, the new resource data to the cloud computing environment to cause the cloud computing environment to instantiate the new resource or modify or disable the existing resource; and generating, by the one or more processors, one or more data objects indicating a compliance status, according to policy, of the new resource or the modified or disabled existing resource.
Example 2. The computer-implemented method of example 1, wherein the policy is associated with one or more of: security, compliance, resource management, data management, application management, or user management.
Example 3. The computer-implemented method of example 1, wherein the one or more resource types include one or more of: a storage account resource, a virtual machine resource, or a network address resource.
Example 4. The computer-implemented method of example 1, further comprising: receiving, by the one or more processors, user input indicative of one or more scenarios against which to validate the policy, wherein determining the one or more resource configurations is further based on the user input.
Example 5. The computer-implemented method of example 1, wherein the new resource data is first new resource data, the processor-executable instructions are first processor-executable instructions, and the new resource is a first new resource, and wherein the computer-implemented method further comprises: generating, by the one or more processors and based at least in part on a second resource configuration of the one or more resource configurations, second new resource data including second processor-executable instructions to newly instantiate a second new resource; providing, by the one or more processors, the second new resource data to the cloud computing environment to cause the cloud computing environment to instantiate the second new resource, obtaining, by the one or more processors, an indication that the second new resource was not instantiated at the cloud computing environment; generating, by the one or more processors, a notification indicating the second new resource was not instantiated at the cloud computing environment; and providing, by the one or more processors, the notification to a computing device.
Example 6. The computer-implemented method of example 1, wherein: the one or more data objects include data of a compliance report; and the computer-implemented method further comprises: providing, by the one or more processors, the compliance report to a computing device.
Example 7. The computer-implemented method of example 1, wherein: the one or more resource configurations are a first one or more resource configurations, the new resource data is first new resource data, the processor-executable instructions are first processor-executable instructions, the new resource is a first new resource, and the existing resource is a first existing resource; the computer-implemented method further comprises determining, by the one or more processors and based at least in part on the resource information, a second one or more resource configurations for a second resource type of the one or more resource types, generating, by the one or more processors and based at least in part on a second resource configuration of the second one or more resource configurations, second new resource data including second processor-executable instructions to newly instantiate a second new resource or modify or disable a second existing resource, and providing, by the one or more processors, the second new resource data to the cloud computing environment to cause the cloud computing environment to instantiate the second new resource or modify or disable the second existing resource; and the one or more data objects further indicate a compliance status, according to the policy, of the second new resource or the modified or disabled second existing resource.
Example 8. The computer-implemented method of example 1, wherein the resource information includes at least one resource attribute, and at least one corresponding attribute value, for at least one resource type of the one or more resource types.
Example 9. The computer-implemented method of example 8, wherein the at least one resource attribute includes one or more of: public accessibility, a storage amount, or a geographic region.
Example 10. The computer-implemented method of example 1, wherein generating the new resource data includes using a machine-learned model to generate the processor-executable instructions to newly instantiate the new resource.
Example 11. The computer-implemented method of example 10, wherein: generating the new resource data includes generating initial new resource data including initial processor-executable instructions to newly instantiate the new resource, providing the initial new resource data to the cloud computing environment to cause the cloud computing environment to instantiate the new resource, and obtaining an indication that the new resource was not instantiated at the cloud computing environment; and using the machine-learned model to generate the processor-executable instructions is in response to the indication that the new resource was not instantiated.
Example 12. A system comprising memory and one or more processors communicatively coupled to the memory, the memory storing instructions that, when executed by the one or more processors, cause the one or more processors to: obtain, by querying a cloud computing environment, policy information of a policy deployed in the cloud computing environment; determine, based at least in part on the policy information, resource information of one or more resource types; determine, based at least in part on the resource information, one or more resource configurations to be tested against the policy for a first resource type of the one or more resource types; generate, based at least in part on a first resource configuration of the one or more resource configurations, new resource data including processor-executable instructions to newly instantiate a new resource or modify or disable an existing resource; provide the new resource data to the cloud computing environment to cause the cloud computing environment to instantiate the new resource or modify or disable the existing resource; andgenerate one or more data objects indicating a compliance status, according to the policy, of the new resource or the modified or disabled existing resource.
Example 13. The system of example 12, wherein the policy is associated with one or more of: security, compliance, resource management, data management, application management, or user management.
Example 14. The system of example 12, wherein the one or more resource types include one or more of: a storage account resource, a virtual machine resource, or a network address resource.
Example 15. The system of example 12, wherein the instructions further cause the one or more processors to: receive a user input indicative of one or more scenarios against which to validate the policy, wherein determining the one or more resource configurations is further based on the user input.
Example 16. The system of example 12, wherein the new resource data is first new resource data, the processor-executable instructions are first processor-executable instructions, and the new resource is a first new resource, and wherein the instructions further cause the one or more processors to: generate, based at least in part on a second resource configuration of the one or more resource configurations, second new resource data including second processor-executable instructions to newly instantiate a second new resource; provide the second new resource data to the cloud computing environment to cause the cloud computing environment to instantiate the second new resource; obtain an indication that the second new resource was not instantiated at the cloud computing environment; generate a notification indicating the second new resource was not instantiated at the cloud computing environment; and provide the notification to a computing device.
Example 17. The system of example 12, wherein: the one or more data objects include data of a compliance report; and the instructions further cause the one or more processors to: provide the compliance report to a computing device.
Example 18. The system of example 12, wherein the resource information includes at least one resource attribute, and at least one corresponding attribute value, for at least one resource type of the one or more resource types.
Example 19. The system of example 12, wherein the instructions cause the one or more processors to generate the new resource data at least in part by using a machine-learned model to generate the processor-executable instructions.
Example 20. One or more non-transitory computer-readable storage media including instructions that, when executed by one or more processors, cause the one or more processors to: obtain, by querying a cloud computing environment, policy information of a policy deployed in the cloud computing environment; determine, based at least in part on the policy information, resource information of one or more resource types; determine, based at least in part on the resource information, one or more resource configurations to be tested against the policy for a first resource type of the one or more resource types; generate, based at least in part on a first resource configuration of the one or more resource configurations, new resource data including processor-executable instructions to newly instantiate a new resource or modify or disable an existing resource; provide the new resource data to the cloud computing environment to cause the cloud computing environment to instantiate the new resource or modify or disable the existing resource; and generate one or more data objects indicating a compliance status, according to the policy, of the new resource or the modified or disabled existing resource.

### Additional Considerations

Throughout this specification, components, operations, or structures described as a single instance may be implemented as multiple instances. Although individual operations of one or more methods are illustrated and described as separate operations, one or more of the individual operations may be performed concurrently or otherwise in parallel, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also comprise programmable logic or circuitry (e.g., as encompassed within a general-purpose processor or other programmable processor) that is temporarily configured by software to perform certain operations. It will be appreciated that the decision to implement a hardware component mechanically, in dedicated and permanently configured circuitry, or in temporarily configured circuitry (e.g., configured by software) may be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Similarly, the methods or routines described herein may be at least partially processor-implemented. For example, at least some of the operations of a method may be performed by one or more processors or processor-implemented hardware components. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented components may be located in a single geographic location (e.g., within a home environment, an office environment, or a server farm). In other example embodiments, the one or more processors or processor-implemented modules may be distributed across a number of geographic locations.

Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which all of the processor(s) (e.g., one or multiple processors in the same device, or multiple processors distributed among multiple devices) contribute to the generation of both X and Y; and (3) other variations.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, but yet still co-operate, transmit between, or interact with each other.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment, but not every embodiment necessarily includes the particular element, feature, structure, or characteristic. The appearances of the phrase “in one embodiment” in various places in the specification are not necessarily all referring to the same embodiment, although it may.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

For the purposes of the present disclosure, the term ‘a’ or ‘an’ entity refers to one or more of that entity. As such, the terms ‘a’ or ‘an’, ‘one or more’, and ‘at least one’ can be used interchangeably herein unless explicitly contradicted by the specification using the word “only one” or similar. For example, “a first element” may functionally be interpreted as “a first one or more elements” or a “first at least one of element.” The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A computer-implemented method comprising:
obtaining, by one or more processors and by querying a cloud computing environment, policy information of a policy deployed in the cloud computing environment;
determining, by the one or more processors and based at least in part on the policy information, resource information of one or more resource types;
determining, by the one or more processors and based at least in part on the resource information, one or more resource configurations to be tested against the policy for a first resource type of the one or more resource types;
generating, by the one or more processors and based at least in part on a first resource configuration of the one or more resource configurations, new resource data including processor-executable instructions to newly instantiate a new resource or modify or disable an existing resource;
providing, by the one or more processors, the new resource data to the cloud computing environment to cause the cloud computing environment to instantiate the new resource or modify or disable the existing resource; and
generating, by the one or more processors, one or more data objects indicating a compliance status, according to policy, of the new resource or the modified or disabled existing resource.

2. The computer-implemented method of claim 1, wherein the policy is associated with one or more of: security, compliance, resource management, data management, application management, or user management.

3. The computer-implemented method of claim 1, wherein the one or more resource types include one or more of: a storage account resource, a virtual machine resource, or a network address resource.

4. The computer-implemented method of claim 1, further comprising:
receiving, by the one or more processors, user input indicative of one or more scenarios against which to validate the policy, wherein determining the one or more resource configurations is further based on the user input.

5. The computer-implemented method of claim 1, wherein the new resource data is first new resource data, the processor-executable instructions are first processor-executable instructions, and the new resource is a first new resource, and wherein the computer-implemented method further comprises:
generating, by the one or more processors and based at least in part on a second resource configuration of the one or more resource configurations, second new resource data including second processor-executable instructions to newly instantiate a second new resource;
providing, by the one or more processors, the second new resource data to the cloud computing environment to cause the cloud computing environment to instantiate the second new resource,
obtaining, by the one or more processors, an indication that the second new resource was not instantiated at the cloud computing environment;
generating, by the one or more processors, a notification indicating the second new resource was not instantiated at the cloud computing environment; and
providing, by the one or more processors, the notification to a computing device.

6. The computer-implemented method of claim 1, wherein:
the one or more data objects include data of a compliance report; and
the computer-implemented method further comprises providing, by the one or more processors, the compliance report to a computing device.

7. The computer-implemented method of claim 1, wherein:
the one or more resource configurations are a first one or more resource configurations, the new resource data is first new resource data, the processor-executable instructions are first processor-executable instructions, the new resource is a first new resource, and the existing resource is a first existing resource;
the computer-implemented method further comprises
determining, by the one or more processors and based at least in part on the resource information, a second one or more resource configurations for a second resource type of the one or more resource types,
generating, by the one or more processors and based at least in part on a second resource configuration of the second one or more resource configurations, second new resource data including second processor-executable instructions to newly instantiate a second new resource or modify or disable a second existing resource, and
providing, by the one or more processors, the second new resource data to the cloud computing environment to cause the cloud computing environment to instantiate the second new resource or modify or disable the second existing resource; and
the one or more data objects further indicate a compliance status, according to the policy, of the second new resource or the modified or disabled second existing resource.

8. The computer-implemented method of claim 1, wherein the resource information includes at least one resource attribute, and at least one corresponding attribute value, for at least one resource type of the one or more resource types.

9. The computer-implemented method of claim 8, wherein the at least one resource attribute includes one or more of: public accessibility, a storage amount, or a geographic region.

10. The computer-implemented method of claim 1, wherein generating the new resource data includes using a machine-learned model to generate the processor-executable instructions to newly instantiate the new resource.

11. The computer-implemented method of claim 10, wherein:
generating the new resource data includes
generating initial new resource data including initial processor-executable instructions to newly instantiate the new resource,
providing the initial new resource data to the cloud computing environment to cause the cloud computing environment to instantiate the new resource, and
obtaining an indication that the new resource was not instantiated at the cloud computing environment; and using the machine-learned model to generate the processor-executable instructions is in response to the indication that the new resource was not instantiated.

12. A system comprising memory and one or more processors communicatively coupled to the memory, the memory storing instructions that, when executed by the one or more processors, cause the one or more processors to:
obtain, by querying a cloud computing environment, policy information of a policy deployed in the cloud computing environment;
determine, based at least in part on the policy information, resource information of one or more resource types;
determine, based at least in part on the resource information, one or more resource configurations to be tested against the policy for a first resource type of the one or more resource types;
generate, based at least in part on a first resource configuration of the one or more resource configurations, new resource data including processor-executable instructions to newly instantiate a new resource or modify or disable an existing resource;
provide the new resource data to the cloud computing environment to cause the cloud computing environment to instantiate the new resource or modify or disable the existing resource; and
generate one or more data objects indicating a compliance status, according to the policy, of the new resource or the modified or disabled existing resource.

13. The system of claim 12, wherein the policy is associated with one or more of: security, compliance, resource management, data management, application management, or user management.

14. The system of claim 12, wherein the one or more resource types include one or more of: a storage account resource, a virtual machine resource, or a network address resource.

15. The system of claim 12, wherein the instructions further cause the one or more processors to:
receive a user input indicative of one or more scenarios against which to validate the policy, wherein determining the one or more resource configurations is further based on the user input.

16. The system of claim 12, wherein the new resource data is first new resource data, the processor-executable instructions are first processor-executable instructions, and the new resource is a first new resource, and wherein the instructions further cause the one or more processors to:
generate, based at least in part on a second resource configuration of the one or more resource configurations, second new resource data including second processor-executable instructions to newly instantiate a second new resource;
provide the second new resource data to the cloud computing environment to cause the cloud computing environment to instantiate the second new resource;
obtain an indication that the second new resource was not instantiated at the cloud computing environment;
generate a notification indicating the second new resource was not instantiated at the cloud computing environment; and
provide the notification to a computing device.

17. The system of claim 12, wherein:
the one or more data objects include data of a compliance report; and
the instructions further cause the one or more processors to provide the compliance report to a computing device.

18. The system of claim 12, wherein the resource information includes at least one resource attribute, and at least one corresponding attribute value, for at least one resource type of the one or more resource types.

19. The system of claim 12, wherein the instructions cause the one or more processors to generate the new resource data at least in part by using a machine-learned model to generate the processor-executable instructions.

20. One or more non-transitory computer-readable storage media including instructions that, when executed by one or more processors, cause the one or more processors to:
obtain, by querying a cloud computing environment, policy information of a policy deployed in the cloud computing environment;
determine, based at least in part on the policy information, resource information of one or more resource types;
determine, based at least in part on the resource information, one or more resource configurations to be tested against the policy for a first resource type of the one or more resource types;
generate, based at least in part on a first resource configuration of the one or more resource configurations, new resource data including processor-executable instructions to newly instantiate a new resource or modify or disable an existing resource;
provide the new resource data to the cloud computing environment to cause the cloud computing environment to instantiate the new resource or modify or disable the existing resource; and
generate one or more data objects indicating a compliance status, according to the policy, of the new resource or the modified or disabled existing resource.
